(19) United States
(12) Patent Application Publication
(10) Pub. No.: US 2015/0092431 A1
(43) Pub. Date: Apr. 2, 2015

(54) HEADLAMPS FOR A VEHICLE

(71) Applicant: GM GLOBAL TECHNOLOGY OPERATIONS LLC, Detroit, MI (US)

(72) Inventors: Ingolf Schneider, Ruesselsheim (DE); Frank Langkabel, Ruesselsheim (DE); Tran Quoc Khanh, Darmstadt (DE)

(21) Appl. No.: 14/500,656

(22) Filed: Sep. 29, 2014

(30) Foreign Application Priority Data
Sep. 28, 2013 (DE) 102013016276.9

(51) Int. Cl. B60Q 1/08; B60Q 1/14

(52) U.S. Cl. CPC B60Q 1/085; B60Q 1/1423; B60Q 2300/45; B60Q 2300/42; B60Q 2300/41
USPC 362/466; 362/543

(57) ABSTRACT

A headlamp for a vehicle, in particular a motor vehicle is disclosed. The headlamp includes a first light source designed to illuminate a central area with a first light spectrum, and a second light source designed to illuminate an edge area with a second light spectrum. The light spectrum of the first light source differs from the light spectrum of the second light source.

### CROSS REFERENCE TO RELATED APPLICATION

This application claims priority to German Patent Application No. 102013016276.9 filed Sep. 28, 2013, which is incorporated herein by reference in its entirety.

### TECHNICAL FIELD

The present disclosure relates to a headlamp, a vehicle with a headlamp, and a method for operating a headlamp.

### BACKGROUND

Various approaches are known for illuminating the area ahead of an automobile. Most headlamps are fitted with a type of lamp, for example halogen incandescent lamps or xenon lamps. Depending on the position of the gear shift drum, these can be used both for low beams and high beams. High beams and low beams thus have the same spectral radiance distribution, both for the area around the optical axis of the headlamps on the road lane ahead, as well as on either edge regions of the road lane. This also holds true for passenger zones in the city or areas next to a country road or the freeway. A city light distribution can be generated by rotating the gear shift drum, or a bending or curving light can be generated by swiveling the headlamps.

Introducing LED technology makes it possible to specifically control light distribution by actuating the LED modules with LEDs and optics, and thereby specifically adjust the light distribution for the low beam, curving light and bending light, as well as the high beam. The low beam and high beam can here be designed either as separate modules or as a combined module.

DE 10 2008 062 640 A1 discloses a vehicle headlamp with a plurality of LED light sources, which are integrated into a shared light-emitting light source matrix, wherein the individual LED light sources can be turned on and/or turned off and/or dimmed so as to change a light distribution of the light-emitting light source matrix.

The entire area to be illuminated is here always illuminated with light from the same, constant spectrum. The light spectrum used here depends on the lamp type, and represents a compromise between various requirements for human vision at twilight or night.

### SUMMARY

The present disclosure provides a headlamp and method for operating a headlamp that enables an improved illumination of the area ahead of a vehicle. It is here especially desirable that it be possible to illuminate the road ahead of the vehicle in such a way that a vehicle can be driven without fatigue, while at the same time also considering the altered way that the human eye sees at twilight, so that objects in the vicinity of the vehicle can still be perceived even given a low light intensity.

In one aspect, the present disclosure provides a headlamp for a vehicle, in particular a motor vehicle, with a first light source designed to illuminate a central area with a first light spectrum, and a second light source designed to illuminate an edge area with a second light spectrum. The first light spectrum differs from the second light spectrum.

A method is also provided for operating a headlamp for a vehicle, in particular a motor vehicle in which a first light source is provided to illuminate a central area with a first light spectrum, and a second light source is provided to illuminate an edge area with a second light spectrum. The second light spectrum differs from the first light spectrum.

A vehicle, in particular a motor vehicle, with a headlamp according to the present disclosure.

A computer-readable medium exhibiting a computer program, which encompasses instructions that prompt a program-controlled device to implement a method according to the present disclosure.

One aspect of the present disclosure is a recognition that that the brightness sensitivity for long-wave light diminishes and the sensitivity to short-wave radiation rises within the mesopic range of the human eye in the dark. On the other hand, especially effortless vision is possible given a light spectrum modeled on daylight. With this understanding, the present disclosure provides an option on the one hand where the central driving area ahead of the vehicle is illuminated in such a way that the vehicle can be driven without fatigue over a prolonged period of time. For this purpose, this central area is illuminated with light that most closely approximates the light spectrum of daylight. In addition, edge areas outside the central driving area are illuminated with a light spectrum deviating from the latter. This light spectrum used to illuminate the edge areas here takes into account the fact that the sensitivity of the human eye in the mesopic range is higher for short-wave radiation than for light with a longer wavelength precisely given a low light intensity.

To this end, one aspect of the present disclosure provides a headlamp for a vehicle that exhibits at least two light sources. The first light source is designed to illuminate a central area with a first light spectrum. This central area preferably involves the driving area ahead of the vehicle. The user must devote utmost attention to this area ahead of the vehicle while driving. For this reason, this central area is preferably illuminated with a light spectrum that very closely approximates daylight. The advantage to this type of light that resembles daylight has to do with the relatively low fatigue experienced by the human eye even over a longer period of time.

The headlamp further has a second light source, which is designed to illuminate an edge area with a second light spectrum. This edge area preferably involves an area within the visible range of the vehicle driver to the left and right of the roadway. For example, this edge area can be a pedestrian or bicycle path running parallel to the lane of the vehicle. The edge areas can also involve additional areas next to the lane of the vehicle. In particular, the edge area can also encompass additional parallel lanes in the traveling direction or an oncoming lane. The edge area can likewise involve road markings that border the lane of the vehicle. Other options for delimiting the central area and edge area are also possible.

In an aspect of the present disclosure, the second light spectrum of the second light source deviates from the first light spectrum of the first light source. As a result, the edge area illuminated by the second light source can be illuminated in such a way that contrasts in this edge area can be better perceived in the dark. Illuminating the edge areas with a light spectrum deviating from the central area makes it possible to improve perception of the edge area, without having to raise the light intensity for this purpose.

Another aspect of the present disclosure further provides for a method suitable for operating a headlamp according to the present disclosure. A first and second light source is provided to this end. The first light source is operated in such a way as to illuminate a central area with a first light spectrum. The second light source is operated in such a way as to illuminate an edge area with a second light spectrum that differs from the first light spectrum.

Finally, another aspect of the present disclosure also provides a vehicle, in particular a motor vehicle, for example a passenger car. The vehicle here exhibits at least one headlamp according to the present disclosure.

A further aspect of the present disclosure makes it possible to divide the area illuminated by a headlamp into at least two partial areas. The individual partial areas can here be illuminated with varying light spectra. As a result, an optimized light spectrum tailored to the special requirements of the respective area can be selected for each individual partial area. In this way, optimized illumination can be achieved for a given partial area, even with a relatively low light intensity. The light spectra can here be efficiently adjusted for each partial area by optimizing the phosphorus of the individual light sources that illuminate the respective partial areas.

Advantageous embodiments and further developments may be gleaned from the specification, drawing reference to the figures in the drawings and the claims as presented.

In an embodiment, the first light source and second light source exhibit phosphorus-converting semiconductor diodes. For example, these phosphorus-converting semiconductor diodes can be light-emitting diodes (LEDs). Using various phosphorus-converting materials in the semiconductor diodes makes it easy to tailor the radiation spectrum to each partial area.

In an embodiment, the first light source and second light source encompass an LED module or an LED-matrix-beam headlamp. Modules and headlamps based on LEDs are very well suited for specifically illuminating the lighting area of a headlamp in various partial areas. Suitable LEDs of the respective module/respective headlamp can here be operated in a targeted manner for selecting the desired light spectrum.

In an embodiment, the headlamp encompasses a control device designed to adjust the edge area illuminated by the second light source. Adjusting the illuminated edge area enables an adaptive adjustment of the illuminated area to changing environmental conditions. To this end, the control device can consider different input parameters for adjusting the illuminated area, and based thereupon alter the illuminated area at the edge.

In an embodiment, the headlamp encompasses a detector designed to detect an object in the vicinity of the vehicle. For example, such a detector can be a camera, an infrared sensor, an ultrasound sensor or a radar sensor. Detecting objects in the vicinity of the vehicle, in particular in the illuminated area of the headlamp, enables the targeted illumination of these objects. In particular, the detected objects can here be illuminated with a separate light spectrum. As a consequence, the detected objects are especially easy to discern in the dark. For this reason, a vehicle driver can perceive the objects early on, and react to potential danger situations in time.

In an embodiment, the detector is designed to classify the detected object, and the control device adjusts the edge area and/or the central area as a function of the object classification. Classifying the objects in this way makes it possible to distinguish between individual objects, and illuminate the individual objects with a different light spectrum as needed, depending on the logged classification. For example, this makes it possible to highlight especially relevant objects, while objects classified as less relevant are not highlighted, and so do not distract a vehicle driver while driving. For example, road markings and in particular curve progressions can be illuminated with a clearly discernible light spectrum. Even individuals on the edge of the road can be specially designated. As a result, driving safety can be significantly increased.

In an embodiment, the second light spectrum exhibits a higher percentage of short-wave light than the first light spectrum. Elevating the percentage of short-wave light makes it possible to enhance the perception of contrasts during scoptic vision, i.e., at twilight. In this way, objects and designations on the edge can be readily perceived without requiring a higher light intensity for this purpose.

In an embodiment, a luminosity of the first light source differs at least partially from a luminosity of the second light source. Adjusting the luminosity of the light sources can additionally accentuate items or objects. Beyond that, reducing the luminosity in partial areas can also reduce a potentially dangerous blinding effect by other traffic participants.

In an embodiment, the first light source and second light source are arranged in the same housing. For example, the light sources can be accommodated in a shared headlamp housing. The two light sources can further also be designed as individual diodes of a single headlamp. This makes it possible to achieve an efficient and space-saving arrangement.

In an embodiment of the method for operating a headlamp, the step for illuminating the edge area with the second light source adaptively adjusts the second light spectrum. In this way, the illuminated area of the headlamp can be adapted to the current circumstances.

An embodiment of the method according to the present disclosure encompasses detecting an object in the vicinity of the vehicle, and adjusting the edge area and/or central area as a function of the detected object. This enables a situation-dependent adaptation of the illuminated area and division into partial areas.

In an embodiment, the method encompasses adjusting a luminosity of the second light source as a function of the detected object. This also makes it possible to adjust the brightness of the individual partial areas depending on the situation.

In order to implement a preferred method, the present disclosure encompasses a device for providing a first light source and a second light source, a device for illuminating a central area by means of the first light source with a first light spectrum, and a device for illuminating an edge area by means of the second light source with a second light spectrum, wherein the second light spectrum differs from the first light spectrum.

In an embodiment, the device for illuminating the edge area with the second light source adaptively adjusts the second light spectrum.

An embodiment encompasses a device for detecting an object in the vicinity of the vehicle, and a device for adjusting the edge area and/or central area as a function of the detected object.

An embodiment encompasses a device for adjusting a luminosity of the second light source as a function of the detected object.

As needed, the above embodiments and further developments can be combined with each other in whatever way desired. Additional possible embodiments, further developments and implementations of the present disclosure also encompass not explicitly mentioned combinations of inventive features described previously or below in relation to the exemplary embodiments. In particular, the expert will also add individual aspects as improvements or enhancements to the respective original form of the present disclosure.

### BRIEF DESCRIPTIONS OF THE DRAWINGS

The present disclosure will hereinafter be described in conjunction with the following drawing figures, wherein like numerals denote like elements.

FIG. 1 is a block diagram of a headlamp from an embodiment of a headlamp according to the present disclosure;

FIG. 2 is an exemplary depiction for illuminating a scene by means of a headlamp according to an embodiment;

FIG. 3 is another exemplary depiction for illuminating a scene by means of a headlamp according to an embodiment; and

FIG. 4 is a flowchart for an embodiment of a method according to the present disclosure.

### DETAILED DESCRIPTION

The attached figures of the drawing are intended to impart a further understanding of the embodiments of the present disclosure. They illustrate embodiments, and in conjunction with the description serve to explain the principles and concepts of the present disclosure. Other embodiments and many of the cited advantages are derived from the drawings. The elements in the drawing are not necessarily shown to scale relative to each other. In the figures on the drawing, identical elements, features and components with an equivalent function and effect are respectively marked with the same reference numbers.

The following detailed description is merely exemplary in nature and is not intended to limit the present disclosure or the application and uses of the present disclosure. Furthermore, there is no intention to be bound by any theory presented in the preceding background or the following detailed description.

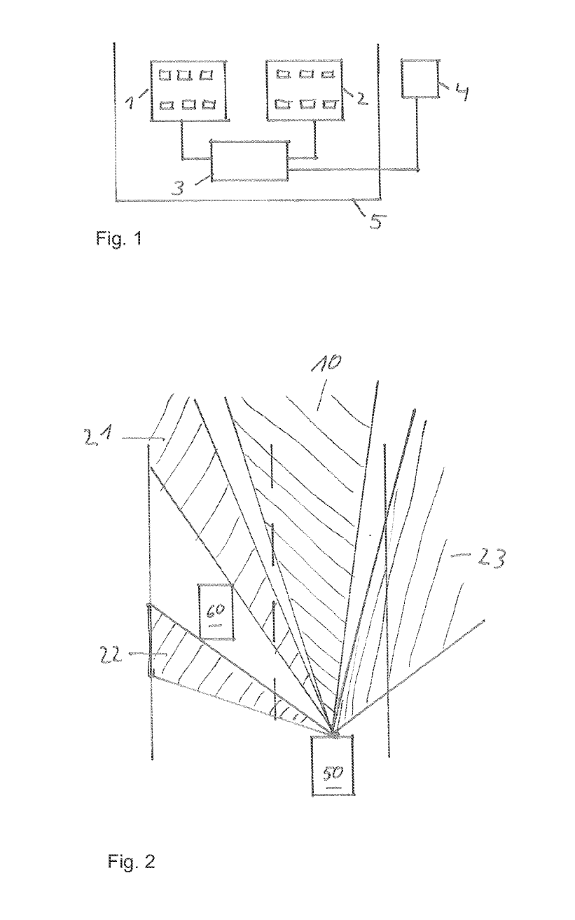

FIG. 1 shows a block diagram of a headlamp in an embodiment of a headlamp according to the present disclosure.

The headlamp encompasses a first light source 1 and a second light source 2. The two light sources 1 and 2 are actuated by the control device 3. The headlamp can further exhibit a camera 4 for detecting objects in the vicinity. The first light source 1 and second light source 2 are here preferably accommodated in a shared housing 5. In an embodiment, the control device 3 is also accommodated in the shared housing 5. As an alternative, the control device 3 can also be situated outside the housing 5. The camera 4 can be arranged either inside the shared housing 5, or also outside this housing 5 at a location especially suitable for detecting objects in the vicinity.

The first light source 1 here emits light with a first light spectrum, while the second light source 2 emits light with a second light spectrum. The two light spectra for the first and second light source 1 and 2 are here respectively adjusted to the areas to be illuminated. For example, if the first light source 1 here illuminates an area that attracts the attention of a user over a longer period of time, a light spectrum can hereby be selected that enables effortless vision over a longer period of time. For example, a light spectrum that most closely approximates daylight can be chosen for this purpose. In like manner, for example, these areas can be illuminated with a light spectrum that exhibits a high percentage of green and/or greenish yellow light. In particular, a light spectrum having a high percentage of light with a wavelength ranging from 530 nm to 570 nm can be selected. Light with such a light spectrum can be perceived especially well by the L-pins and M-pins of the human eye. This allows for effortless, high-resolution vision over a longer period of time around an optical eye axis of +/−5 degrees. As a result, the aforementioned light spectrum is especially well suited for illuminating a central viewing area, for example the central area of the lane ahead of a vehicle.

Light source 2 preferably illuminates peripheral edge areas. These edge areas can here be illuminated by light with a spectrum deviating from the light spectrum of the first light source 1. For example, a light spectrum with a high percentage of blue light can be used. The second light source 2 preferably emits light with a high percentage of light having a wavelength of up to 520 nm. Light with such a light spectrum is especially readily perceived by the rods in the human eye. These rods in the mesopic range of the human eye are preferably active when viewing at twilight (scotopic vision). The rods in the human eye are highly peripherally distributed on the retina with a maximum of 17° of the optical eye axis, and present with a high density even up to an angle of up to 40-50°. For this reason, the light spectrum described above with a high percentage of short-wave light is especially well suited for illuminating peripheral edge areas.

The edge area next to the lane of a vehicle is here preferably illuminated with a luminance of 0.1 to 0.3 cd/m². This numerical value here relates to light corresponding to day vision (photopic luminance). Subjective perception by humans can be improved by now using light with an adjusted light spectrum for the edge area to be illuminated, in which the rods of the human eye are active (mesopic range). For example, if the percentage of light relevant for night vision (scoptic vision) by comparison to that of light relevant for day vision (photopic vision) increases to a ratio of about 2:1, a subjective luminance of about 0.135 cd/m² can hereby be achieved at a photopic luminance of 0.1 cd/m². As a consequence, the adjusted light spectrum increases the detection capacity in the edge area by approx. 35%, without having to raise the effective light intensity for this purpose. This makes it possible to improve perception by a user in the edge area without increasing the energy required by the light source 2.

The first light source 1 or second light source 2 is here preferably designed as LED modules or LED matrix headlamps. In such components, the light is emitted by light-emitting diodes (LEDs) in the form of phosphorus-converting semiconductor diodes. The light spectrum emitted by each LED can here be individually set. As a consequence, an optimized spectrum can be chosen for each of the two light sources 1 and 2 by suitably selecting the LEDs for the first light source 1 and second light source 2.

The two light sources 1 and 2 here preferably each exhibit several LEDs. Each of these LEDs here illuminates a prescribed area. As a consequence, the respective area to be illuminated can be controlled by specifically actuating the individual LEDs in the first light source 1 or second light source 2. This makes it possible to specifically influence the areas illuminated by the respective light source 1 or 2 by activating and deactivating individual LEDs in the two light sources 1 or 2.

A control device 3 can specifically select and actuate individual LEDs in the first light source 1 and/or second light source 2 so as to influence the area illuminated by the respective light source. To this end, for example, a detector 4 can detect an object in the vicinity, and the control device 3 can actively adjust the areas to be illuminated based upon this detection. For example, the detector 4 can be a camera, e.g., a CCD or CMOS camera. Additionally or alternatively, the detector 4 can also exhibit one or more infrared sensors, radar sensors, ultrasound sensors or the like, which are suitable for dynamically monitoring events in traffic.

If necessary, the detector 4 can initially classify the detected objects in the vicinity. This permits an allocation to determine how a detected object is to be illuminated. For example, if the detected object is a road marking, it is preferable that the latter be specially highlighted. To this end, a second lighting unit 2 can light up the detected road markings, for example with a light spectrum that very closely approximates the white light. As a result, the user can readily discern the road progression, and if needed react in time to curves or the like. In like manner, for example, people or animals on the edge of the road can be detected, classified, and also suitably highlighted. On the other hand, other traffic participants, for example vehicles ahead or oncoming vehicles, can be detected and classified as well. In order to prevent other traffic participants from being impaired by a potential blinding effect, such a detected object can in this instance be exposed to only an attenuated light. This can be done on the one hand by adjusting the selected light spectrum. In addition, it is also possible to reduce the light intensity of the respective light source 1 or 2 in the area of the detected object.

FIG. 2 presents a schematic depiction of a zone illuminated by a headlamp according to an embodiment. The first light source 1 of the vehicle 50 illuminates a central area 10 with a first light spectrum. In addition, markings for the lane were detected on the edge of the road. These road markings are highlighted by the second light source 2 with a second light spectrum. An oncoming vehicle 60 is also detected. This oncoming vehicle 60 is excluded when lighting up the left road markings to prevent the other traffic participants from being blinded.

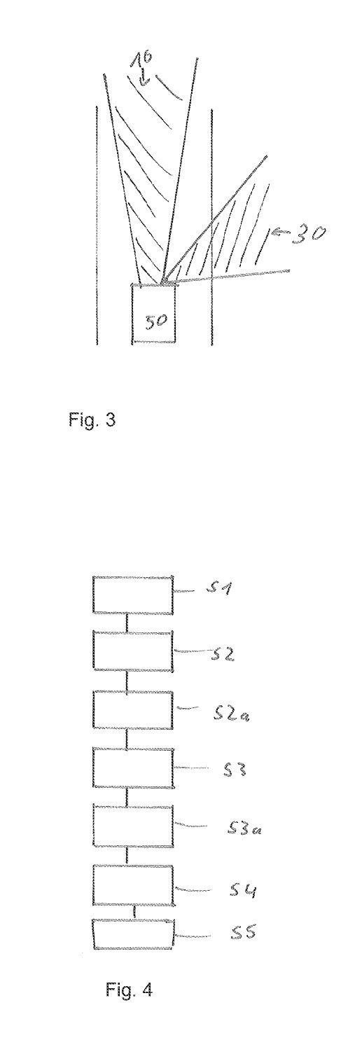

FIG. 3 presents another schematic depiction of a zone illuminated by a headlamp according to an embodiment. The first light source 1 in the vehicle 50 here also illuminates the central area 10 with a first light spectrum. In addition, a second light source 2 illuminates the right edge 30 with a second light spectrum. The second light spectrum here preferably exhibits a higher percentage of short-wave light than the first light spectrum. As a consequence, the first light spectrum also makes it possible to see the lane without any fatigue over a longer period of time, while the second light spectrum still allows a good detection of contrasts in particular relative to the edge areas, even given a relatively low luminance, so that potential dangers along the edge can be detected.

FIG. 4 presents a flowchart for a method of operating a headlamp for a vehicle, in particular for a motor vehicle. A first light source 1 and a second light source 2 are provided in step S1. The central area is illuminated by the first light source 1 with a first light spectrum in step S4, and the edge area is illuminated by a second light source 2 with a second light spectrum in step S5, wherein the second light spectrum differs from the first light spectrum.

If needed, the edge area illuminated by the second light source can be actively adjusted in an optional step S3. To this end, an object can be detected in the environment of the vehicle in step S2, after which the edge area and/or central area can be adjusted as a function of the detected object in step S2a. In addition, the luminosity of the second light source can also be adjusted as a function of a detected object in step S3a.

Even though the present disclosure is completely described above based upon preferred exemplary embodiments, it is not limited thereto, but rather can be modified in a plurality of ways. Thus, while at least one exemplary embodiment has been presented in the foregoing detailed description, it should be appreciated that a vast number of variations exist. It should also be appreciated that the exemplary embodiment is only an example, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1-15. (canceled)

16. A headlamp for a vehicle comprising:
a first light source configured to illuminate a central area ahead of the vehicle with a first light spectrum; and
a second light source configured to illuminate an edge area with respect to the central area with a second light spectrum;
wherein the first light spectrum differs from the second light spectrum.

17. The headlamp according to claim 16, wherein the first light source and second light source comprise phosphorus-converting semiconductor diodes.

18. The headlamp according to claim 16, wherein the first light source and second light source comprise at least one of an LED module or an LED matrix beam headlamp.

19. The headlamp according to claim 16 further comprising a control device configured to adjust the edge area illuminated by the second light source.

20. The headlamp according to claim 16 further comprising a detector configured to detect an object in the vicinity of the vehicle.

21. The headlamp according to claim 20, wherein the detector is further configured to classify the object detected in the vicinity of the vehicle, and the control device is further configured to adjust at least one of the edge area and the central area as a function of the classification of the object.

22. The headlamp according to claim 16, wherein the second light spectrum exhibits a higher percentage of short-wave light than the first light spectrum.

23. The headlamp according to claim 16, wherein a luminosity of the first light source differs from a luminosity of the second light source.

24. The headlamp according to claim 16 further comprising a shared housing wherein the first light source and second light source are arranged therein.

25. A motor vehicle comprising a headlamp according to claim 16.

26. A method for operating a headlamp for a vehicle comprising :
illuminating a central area ahead of the vehicle with a first light spectrum by means of a first light source; and
illuminating an edge area with respect to the central area with a second light spectrum by means of the second light source;
wherein the second light spectrum differs from the first light spectrum.

27. The method according to claim 26, further comprising adaptively adjusting the second light spectrum for illuminating the edge area by means of the second light source.

28. The method according to claim 26 further comprising:
detecting an object in the vicinity of the vehicle; and
adjusting at least one of the edge area and the central area as a function of a detected object.

29. The method according to claim 28 further comprising adjusting a luminosity of the second light source as a function of the detected object.

30. A non-transitory computer-readable medium containing a computer program configured to make a computer executed a method for operating a headlamp for a vehicle of the type having a first light source and a second light source, the method according to claim 26.
